(19) United States
(12) Patent Application Publication
(10) Pub. No.: US 2022/0309570 A1
(43) Pub. Date: Sep. 29, 2022

(54) Multicomputer System for Dynamic Data Retrieval and Processing

(71) Applicant: Bank of America Corporation, Charlotte, NC (US)

(72) Inventors: Carmina A. Serrano, West Hartford, CT (US); Lance P. Horton, Biddeford, ME (US); Beth J. Adamson, Wheaton, IL (US); Julie Anne McClure, Pleasant Hill, CA (US); Susan M. Goeldner, Parker, CO (US); Zeal J. Shah, Cummings, GA (US)

(21) Appl. No.: 17/213,421

(22) Filed: Mar. 26, 2021

(51) Int. Cl. G06Q 40/02; G06F 16/538; G06F 16/583; G06F 16/54

(52) U.S. Cl. CPC G06Q 40/02; G06F 16/538; G06F 16/583; G06F 16/54

(57) ABSTRACT

Systems for dynamic data retrieval and processing are provided. In some aspects, a request to redeem an instrument may be received. Responsive to authenticating the user, a scan of the instrument being redeemed may be performed. Image data, metadata, and the like, may be captured. In some examples, the request to redeem the instrument, as well as the scanned instrument data, may be received by a computing platform. In response to receiving the data and request to redeem the instrument, the computing platform may initiate a communication session with a third party or external entity computing system. Some or all of the scanned image data may be transmitted to the external entity system for determining whether the instrument is valid and for determining, in real-time, a value associated with the instrument. Based on the validity and value data, the request to redeem the instrument may be processed or rejected.

### BACKGROUND

Aspects of the disclosure relate to electrical computers, systems, and devices performing dynamic data retrieval and processing functions.

Conventional systems for redeeming various instruments, such as savings bonds, may involve manual processes, data retrieval from native tables that are infrequently updated, and processing of each instrument individually. In some arrangements, when a large number of instruments are being redeemed, the instruments must be processed at an alternate location, rather than in a banking center. These systems and processes may be extremely inefficient and prone to inaccuracies. Accordingly, a dynamic system for initiating communication with a third party system to obtain real-time data associated with validity, interest, and the like, would be advantageous.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure provide effective, efficient, scalable, and convenient technical solutions that address and overcome the technical problems associated with performing instrument redemption functions.

In some aspects, a request to redeem one or more instruments, such as a savings bond, may be received. The request may be initially received by a local user computing device where, in some examples, a user may be authenticated. Responsive to authenticating the user, a scan of one or more instruments being redeemed may be performed. In some examples, the scan may be performed by a driverless device controlled by the local user computing device. Image data, metadata, and the like, may be captured.

In some examples, the request to redeem the one or more instrument, as well as the scanned instrument data, may be received by a computing platform. In response to receiving the data and request to redeem the one or more instruments, the computing platform may initiate a communication session with a third party or external entity computing system. Some or all of the scanned image data may be transmitted to the external entity system for determining whether the one or more instruments are valid and for determining, in real-time, a value associated with each instrument. Validity and value data may be transmitted from the external entity computing system to the computing platform.

Based on the validity and value data, the request to redeem one or more instruments may be processed or rejected. In some arrangements, a notification may be generated indicating a redemption output.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. lA and 1B depict an illustrative computing environment for implementing dynamic instrument redemption functions in accordance with one or more aspects described herein;

FIGS. 2A-2G depict an illustrative event sequence for implementing instrument redemption functions in accordance with one or more aspects described herein;

FIG. 3 depicts an illustrative method for implementing instrument redemption functions according to one or more aspects described herein;

FIGS. 4 and 5 illustrate example interactive user interfaces that may be generated and/or displayed in accordance with one or more aspects described herein;

FIGS. 6A-6C illustrate example user interfaces that may be generated and/or displayed in accordance with one or more aspects described herein;

FIG. 7 illustrates one example environment in which various aspects of the disclosure may be implemented in accordance with one or more aspects described herein; and

FIG. 8 depicts an illustrative block diagram of workstations and servers that may be used to implement the processes and functions of certain aspects of the present disclosure in accordance with one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As discussed above, conventional arrangements for redeeming instruments, such as savings bonds, are often manual processes that are extremely inefficient and may be prone to errors that will require later correction. For instance, conventional arrangements require a banking associate to access native tables that are infrequently updated (e.g., twice per year) to obtain information to calculate interest associated with the instrument and determine a value for redemption. Further, large numbers of bonds cannot be processed at traditional banking centers due to the time and processing required to conduct these processes. Accordingly, users looking to redeem several bonds may have to wait to redeem the bonds while the bonds are evaluated.

As discussed herein, arrangements described provide technical solutions to the inefficiencies associated with conventional systems by providing dynamic data retrieval and instrument processing. As discussed more fully herein, users may request redemption for one or more instruments, such as a savings bond, at, for instance, a banking associate work station. The banking associate may validate the user and may scan each instrument being redeemed. The scanned instrument data may then be transmitted to a computing platform for processing.

Upon receiving the scanned instrument data, the computing platform may automatically (e.g., without user interaction) establish a communication session with an external entity computing system storing real-time validity and interest/value data. The scanned instrument data may be transmitted to the external entity computing system to determine validity and value associated with the instrument. This data may then be received by the computing platform and stored and/or displayed via the local user computing device. If the instrument is valid, the redemption may be processed and a redemption output notification may be generated and transmitted for display.

These and various other arrangements will be discussed more fully below.

FIGS. 1A-1B depict an illustrative computing environment for implementing and using dynamic instrument redemption functions in accordance with one or more aspects described herein. Referring to FIG. 1A, computing environment 100 may include one or more computing devices and/or other computing systems. For example, computing environment 100 may include instrument redemption computing platform 110, internal entity computing system 120, a first local user computing device 150, a second local user computing device 155, a remote user computing device 170, and an external entity computing system 140. Although one internal entity computing system 120 and one external entity computing system are shown, additional devices or systems may be used without departing from the invention.

Instrument redemption computing platform 110 may be configured to provide intelligent, dynamic instrument redemption functions. For instance, instrument redemption computing platform 110 may receive image and/or metadata associated with an instrument and a request for redemption. In some examples, the instrument may be scanned via a driverless device in communication with or connected to one or more of local user computing device 150, 155. In some arrangements, scanning the instrument may include physically moving the instrument through the scanning device.

The image data and/or metadata captured may be transmitted from the local user computing device 150, 155, to the instrument redemption computing platform 110. Responsive to receiving the data (and, for example, a request for redemption) the instrument redemption computing platform may initiate a communication session with an external entity computing system 140. In some examples, the external entity computing system 140 may be a government or other supervising entity system storing or including data related to registration of the instrument (e.g., to verify validity of the instrument), value of the instrument (e.g., current/real-time interest accrued on the instrument), as well as other data. In some examples, initiating the communication session with the external entity computing system 140 may include connecting with or otherwise accessing data via an application programming interface (API) associated with the external entity of the external entity computing system 140. In some examples, the communication session may be initiated automatically (e.g., without user interaction).

The instrument redemption computing platform 110 may transmit the image and/or metadata to the external entity computing system 140 to verify the validity of the instrument and/or determine a value of the instrument for redemption. Accordingly, the image or metadata may include a face value of the instrument, a type of instrument (e.g., savings bond, or the like), a series of the instrument, magnetic ink character recognition (MICR) line data, and the like. External entity computing system 140 may receive this information and determine a validity of the instrument, determine a purchase date of the instrument, identify interest accrued, and determine a value for redemption. The external entity computing system 140 may then transmit this data to the instrument redemption computing platform 110. In some examples, the connection to the external entity computing system 140, determination of validity, value, and the like, may be performed in real-time and may include real-time data (e.g., real-time interest data).

The instrument redemption computing platform 110 may receive the validity and value data and may integrate the received validity and value data into data in one or more databases of the enterprise organization implementing the instrument redemption computing platform 110. Based on the validity and value data, the instrument may be redeemed (e.g., an amount of funds associated with the determined value may be transferred to a requesting user, user account, or the like) and a redemption output may be generated. The redemption output may be transmitted to, for instance, local user computing device 150, for display.

Internal entity computing system 120 may be computing devices associated with the entity or enterprise organization implementing the instrument redemption computing platform 110. For instance, internal entity computing system 120 may be a system internal to the enterprise organization implementing the instrument redemption computing platforml 110. The internal entity computing system 120 may be configured to store user profile data, user account data, and the like. In some examples, internal entity computing system 120 may host or execute one or more applications associated with systems of the enterprise organization.

External entity computing system 140 may be computing systems or devices associated with an entity external to the enterprise organization. For instance, external entity computing system 140 may be associated with an entity different from the enterprise organization implementing the instrument redemption computing platform 110 and may, in some examples, be associated with a government entity or other supervising or administrative entity. As discussed herein, external entity computing system 140 may execute or host one or more applications associated with instrument redemption and configured to determine validity of an instrument, identify a current (e.g., real-time) value of the instrument, and the like. External entity computing system 140 may store redemption information as discussed herein.

Local user computing device 150, local user computing device 155, and the like, may be computing devices associated with or used by one or more employees of the enterprise organization to perform various job functions. The computing devices 150, 155 may include various types of user computing devices and may display one or more user interfaces, execute applications configured to process redemption requests, initiate and control scanning functions of a scanning device, receive user authentication information, authenticate a user, and the like.

The remote user computing device 170 may be used to communicate with, for example, one or more systems, computing platforms, devices, or the like. In some examples, remote user computing device 170 may be a device associated with a user requesting redemption of the instrument. In some arrangements, authentication data of the user may be transmitted via the remote user computing device 170.

Computing environment 100 also may include one or more computing platforms. For example, and as noted above, computing environment 100 may include instrument redemption computing platform 110. As illustrated in greater detail below, instrument redemption computing platform 110 may include one or more computing devices configured to perform one or more of the functions described herein. For example, instrument redemption computing platform 110 may include one or more computers (e.g., laptop computers, desktop computers, servers, server blades, or the like).

As mentioned above, computing environment 100 also may include one or more networks, which may interconnect one or more of instrument redemption computing platform 110, internal entity computing system 120, external entity computing system 140, local user computing device 150, local user computing device 155, and/or remote user computing device 170. For example, computing environment 100 may include private network 190 and public network 195.

Private network 190 and/or public network 195 may include one or more sub-networks (e.g., Local Area Networks (LANs), Wide Area Networks (WANs), or the like). Private network 190 may be associated with a particular organization (e.g., a corporation, financial institution, educational institution, governmental institution, or the like) and may interconnect one or more computing devices associated with the organization. For example, instrument redemption computing platform 110, internal entity computing system 120, local user computing device 150, and local user computing device 155, may be associated with an enterprise organization (e.g., a financial institution), and private network 190 may be associated with and/or operated by the organization, and may include one or more networks (e.g., LANs, WANs, virtual private networks (VPNs), or the like) that interconnect instrument redemption computing platform 110, internal entity computing system 120, local user computing device 150, local user computing device 155, and one or more other computing devices and/or computer systems that are used by, operated by, and/or otherwise associated with the organization. Public network 195 may connect private network 190 and/or one or more computing devices connected thereto (e.g., instrument redemption computing platform 110, internal entity computing system 120, local user computing device 150, local user computing device 155) with one or more networks and/or computing devices that are not associated with the organization. For example, external entity computing system 140 and/or remote user computing device 170, might not be associated with an organization that operates private network 190 (e.g., because external entity computing system 140, remote user computing device 170, may be owned, operated, and/or serviced by one or more entities different from the organization that operates private network 190, one or more customers of the organization, one or more employees of the organization, public or government entities, and/or vendors of the organization, rather than being owned and/or operated by the organization itself), and public network 195 may include one or more networks (e.g., the internet) that connect external entity computing system 140 and remote user computing device 170 to private network 190 and/or one or more computing devices connected thereto (e.g., instrument redemption computing platform 110, internal entity computing system 120, local user computing device 150, local user computing device 155).

Referring to FIG. 1B, instrument redemption computing platform 110 may include one or more processors 111, memory 112, and communication interface 113. A data bus may interconnect processor(s) 111, memory 112, and communication interface 113. Communication interface 113 may be a network interface configured to support communication between instrument redemption computing platform 110 and one or more networks (e.g., private network 190, public network 195, or the like). Memory 112 may include one or more program modules having instructions that when executed by processor(s) 111 cause instrument redemption computing platform 110 to perform one or more functions described herein and/or one or more databases that may store and/or otherwise maintain information which may be used by such program modules and/or processor(s) 111. In some instances, the one or more program modules and/or databases may be stored by and/or maintained in different memory units of instrument redemption computing platform 110 and/or by different computing devices that may form and/or otherwise make up instrument redemption computing platform 110.

For example, memory 112 may have, store and/or include an authentication module 112a. Authentication module 112a may store instructions and/or data that may cause or enable the instrument redemption computing platform 110 to receive an authentication indication from, for instance, local user computing device 150 (e.g., based on authentication data received from the user and pre-stored authentication data). In some examples, authentication data from a user may be received and compared to pre-stored authentication data (e.g., received from internal entity computing system 120) and the user may be authenticated by the authentication module 112a.

Instrument redemption computing platform 110 may further have, store and/or include scanned instrument data module 112b. Scanned instrument data module 112b may store instructions and/or data that may cause or enable the instrument redemption computing platform 110 to receive image data and/or metadata from, for instance, local user computing device 150 and/or a scanning device in communication with the local user computing device 150. The scanned instrument data module 112b may extract data to be transmitted to the external entity computing system 140 for validation of the instrument and value determination.

Instrument redemption computing platform 110 may further have, store and/or include data transmission module 112c. Data transmission module 112c may store instructions and/or data that may cause or enable the instrument redemption computing platform 110 to, in response to receiving scanned instrument data (e.g., image data, metadata, and the like), initiate a communication session with external entity computing system 140. Once a communication session is established, data transmission module 112c may transmit extracted data to determine validity and/or value to the external entity computing system 140. After the validity and value determinations are made, the data transmission module 112c may receive data including an indication of validity, a value of the instrument, and the like.

Instrument redemption computing platform 110 may further have, store and/or include external data integration module 112d. External data integration module 112d may receive the validity indication and value and may integrate that data into enterprise organization data (e.g., store in, for instance, database 112f, internal entity computing system 120, or the like). In some examples, the external data may be formatted prior to integration. Additionally or alternatively, the data may be received in a format that enables integration without additional formatting or modification.

Instrument redemption computing platform 110 may further have, store and/or include redemption processing module 112e. Redemption processing module 112e may store instructions and/or data that may cause or enable the instrument redemption computing platform 110 to, based on the validity data and value data, process the requested redemption. In some examples, that may include communicating with one or more enterprise organization systems to obtain data (e.g., account data or the like). In some arrangements, processing the redemption request may include transferring an amount of funds equal to the value of the instrument to a user, user account, or the like. The redemption processing module 112e may further generate one or more redemption notifications including one or more user interfaces that may be transmitted to, for instance, local user computing device 150, for display.

Instrument redemption computing platform 110 may further have, store and/or include one or more databases 112f. Database 112f may store data including validity data, value data, redemption processing data, user data, account data, and the like.

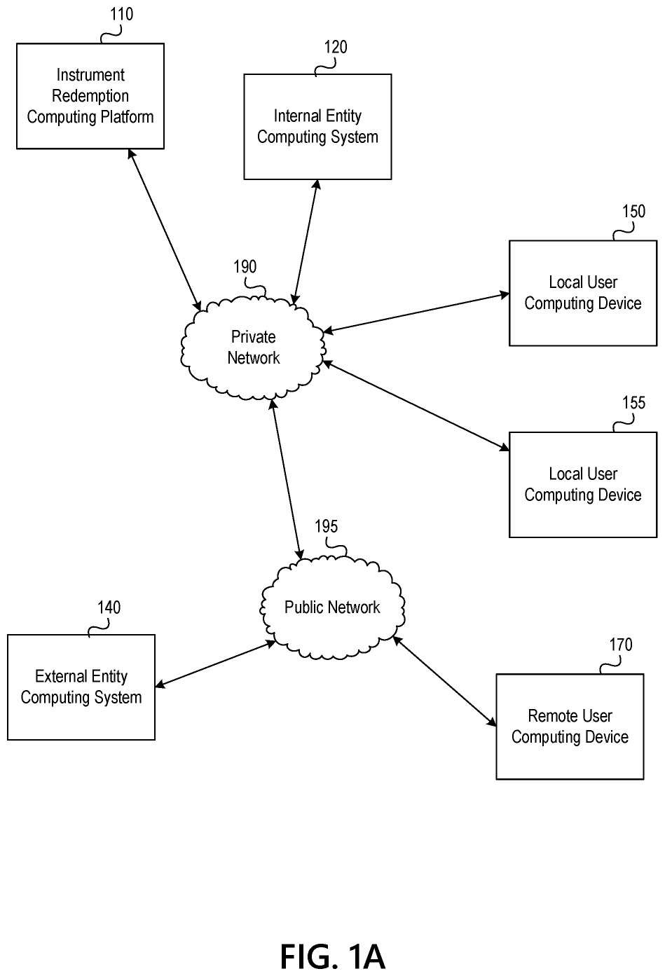

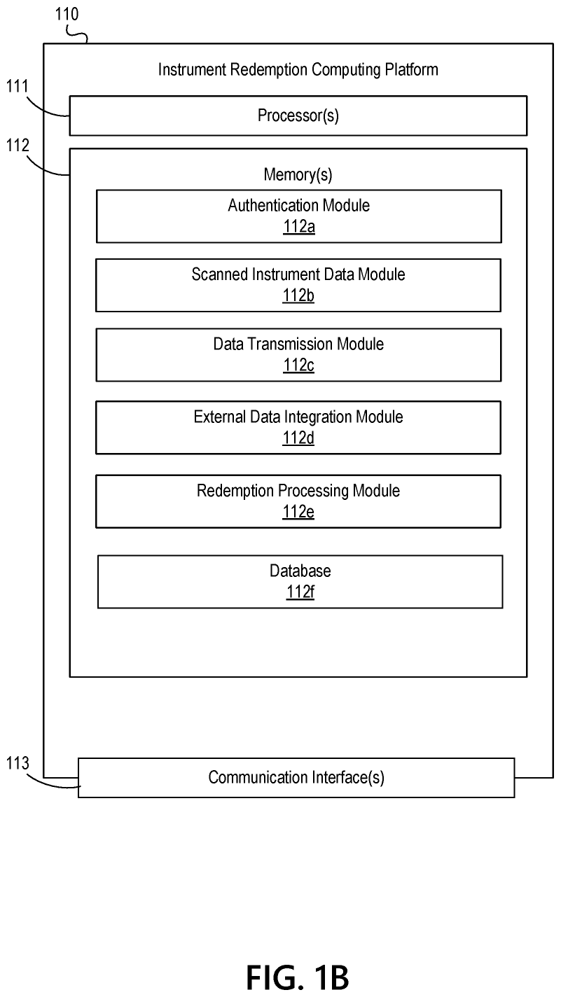

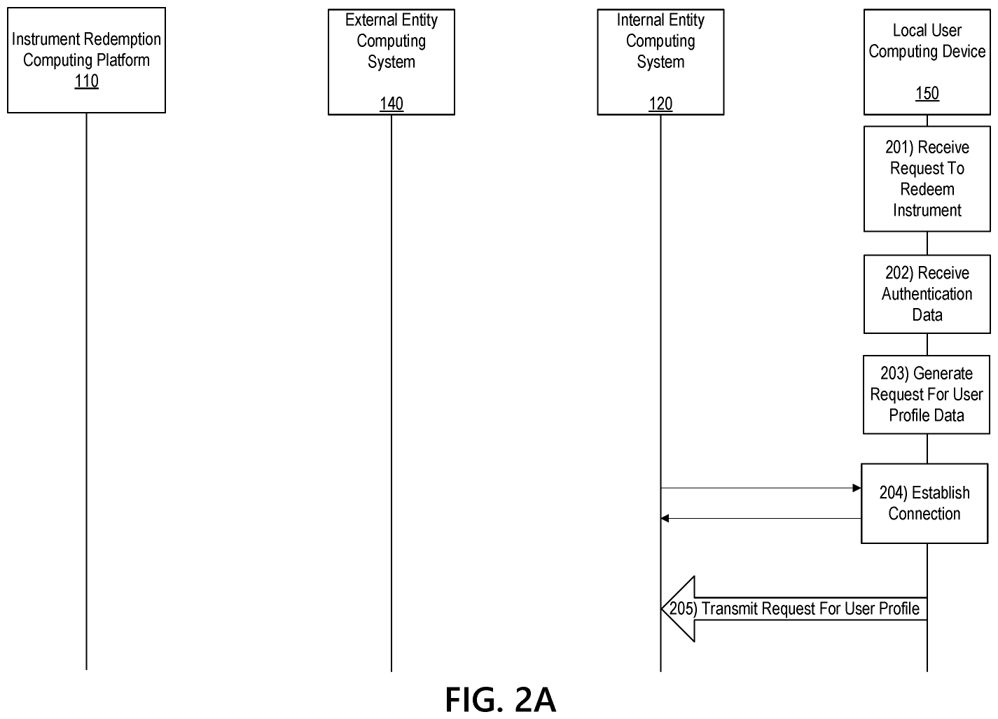

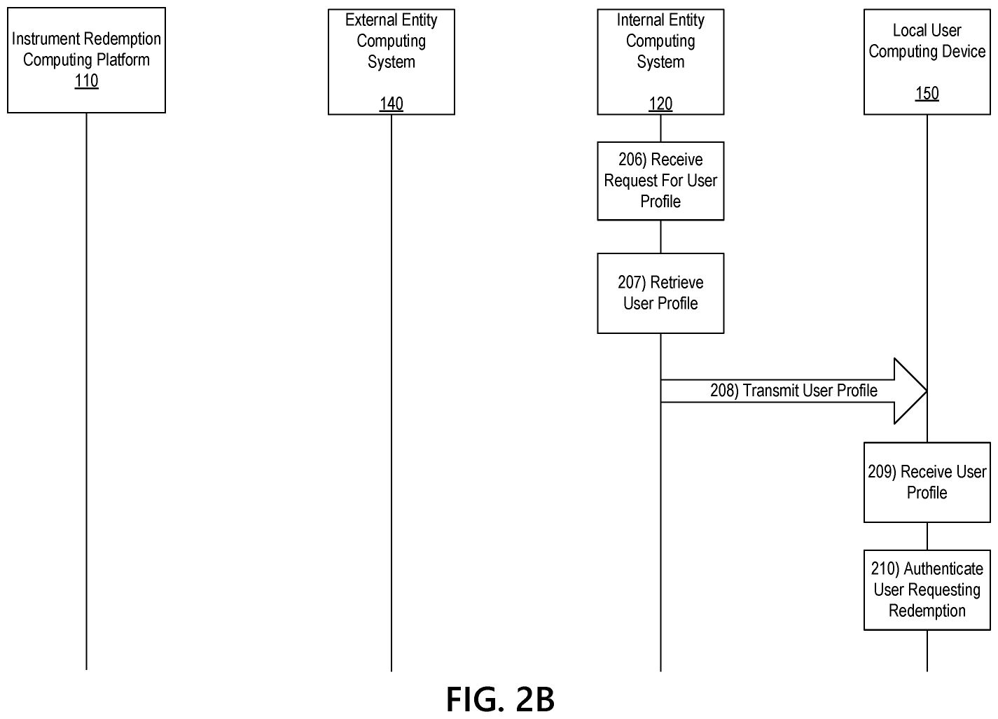

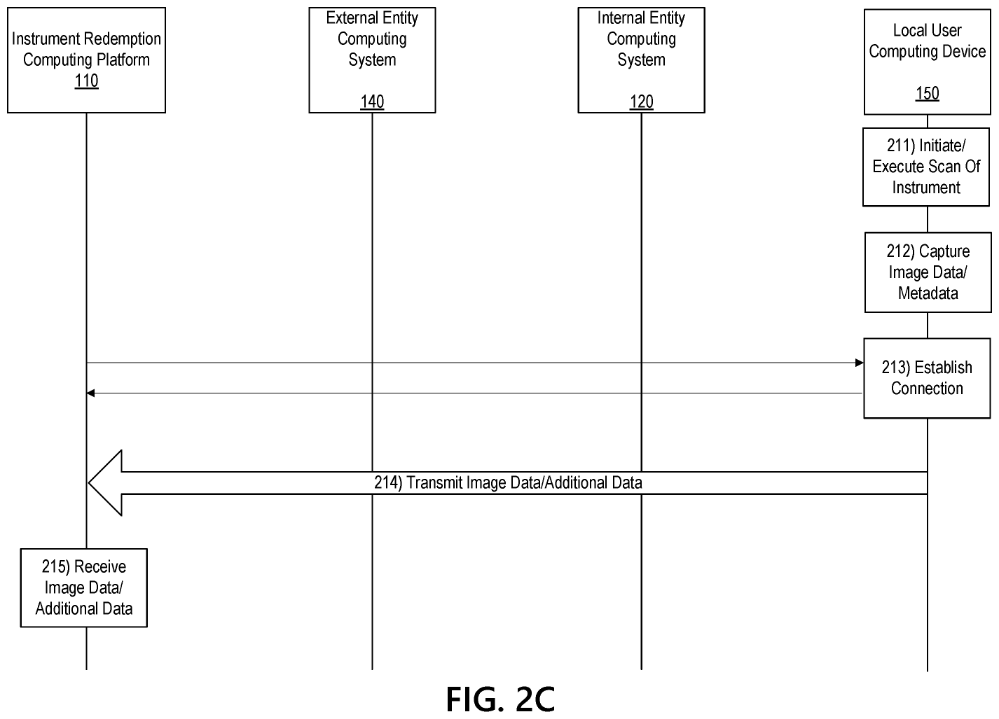

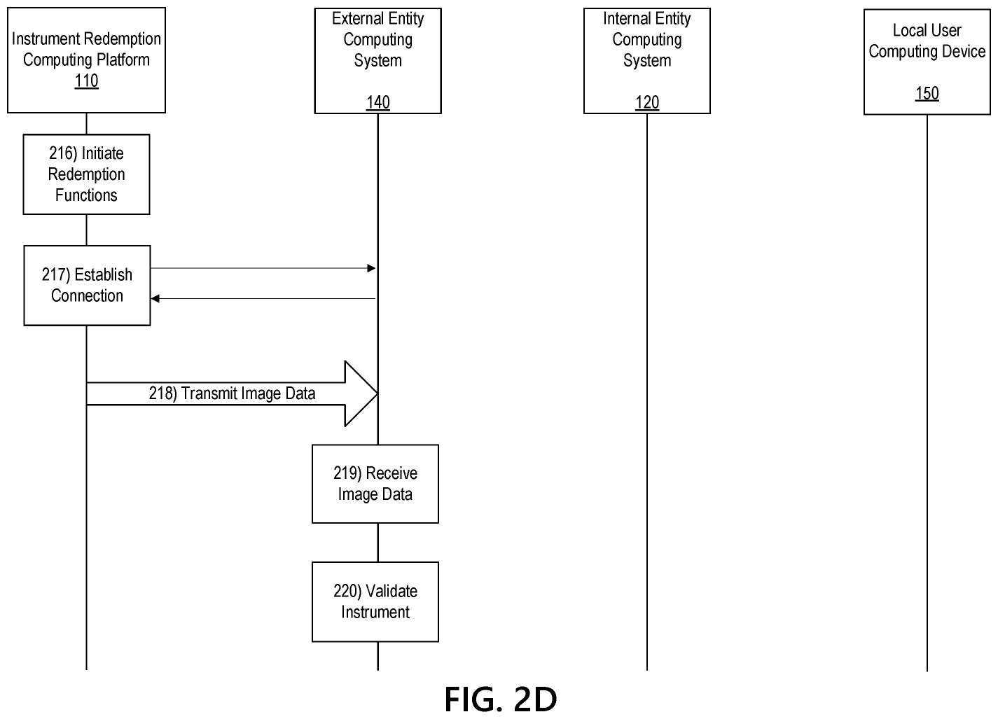

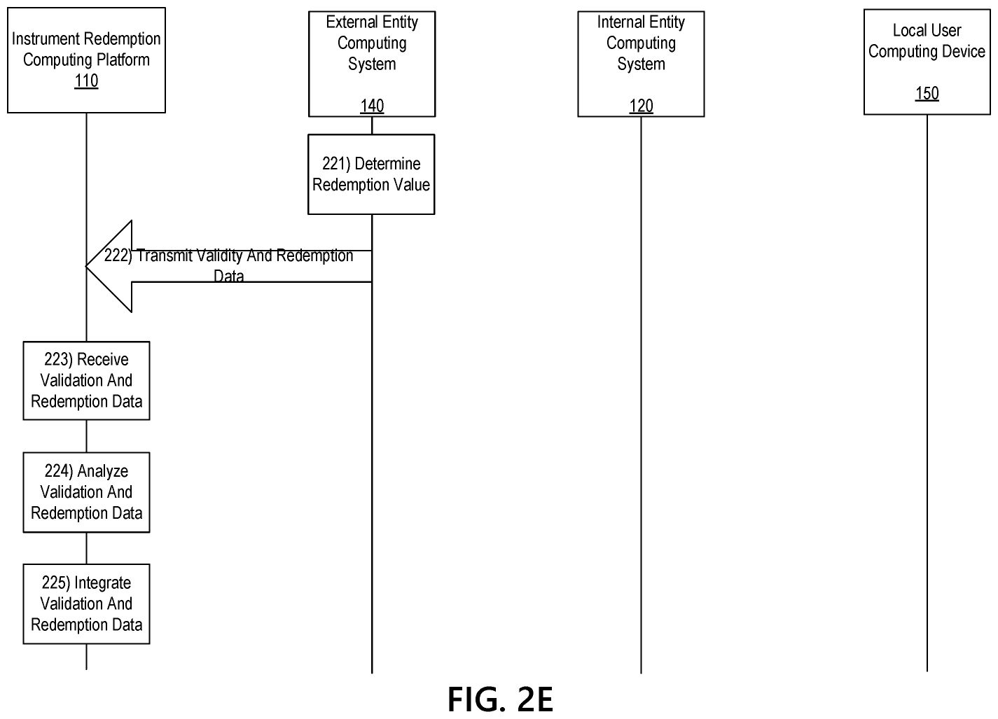

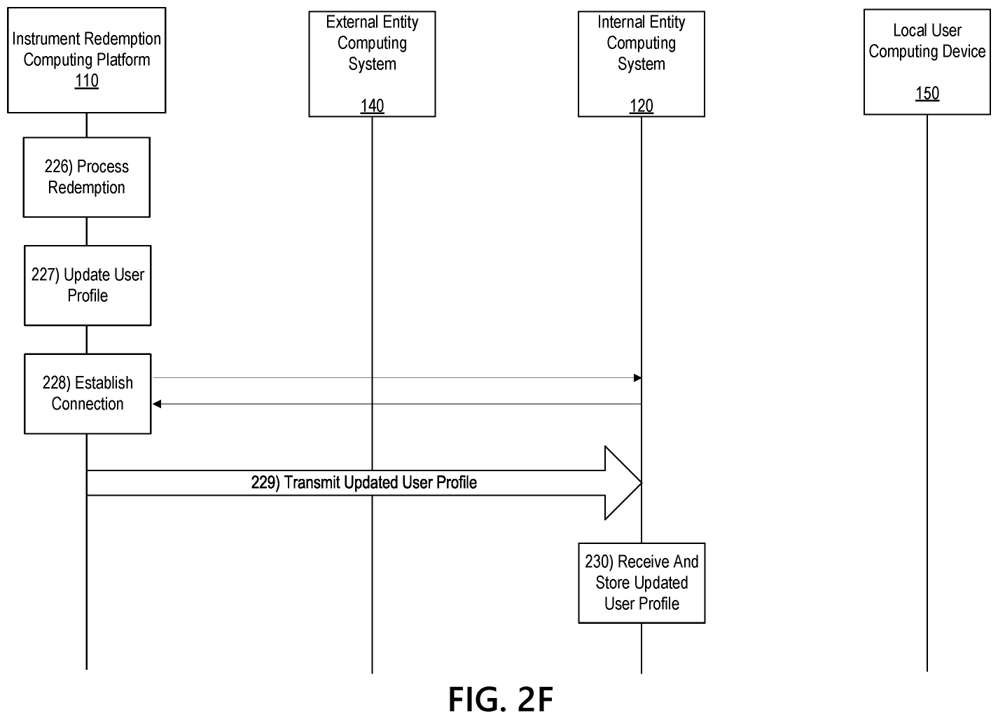

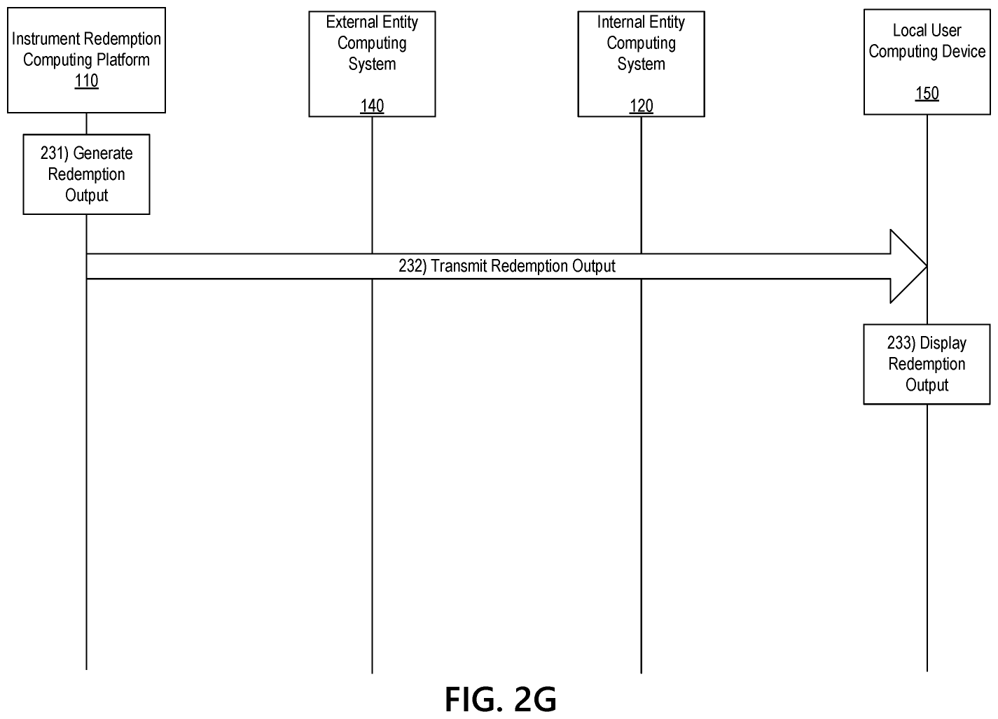

FIGS. 2A-2G depict one example illustrative event sequence for implementing and using dynamic instrument redemption functions in accordance with one or more aspects described herein. The events shown in the illustrative event sequence are merely one example sequence and additional events may be added, or events may be omitted, without departing from the invention.

Referring to FIG. 2A, at step 201, the local user computing device 150 may receive a request to redeem an instrument, such as a savings bond. In some examples, the request to redeem the savings bond may include additional information associated with the user requesting redemption, user associated with the savings bond (e.g., named on the bond), and the like. In some examples, the request to redeem the instrument may include selecting or inputting option data into a user interface displayed or rendered on the local user computing device.

At step 202, authenticating information of the user may be received by the local user computing device. For instance, a username and password, personal identification number, biometric data, or the like, may be received. In some examples, the authenticating information may be input into one or more user interfaces at the local user computing device 150 in order to confirm authentication.

At step 203, a request for user profile data may be generated by the local user computing device 150. For instance, the local user computing device 150 may identify a user (e.g., based on information or data received with the request to redeem, with the authentication data, or the like) generate a database query with the user identity or other information as input. In some examples, a user profile may store data associated with the user (e.g., identifying information, pre-stored authentication information, and the like). Additionally or alternatively, a user profile may store data related to transaction history of the user, account information of the user, and the like.

At step 204, a connection may be established between the local user computing device 150 and the internal entity computing system 120. For instance, a first wireless connection may be established between the local user computing device 150 and the internal entity computing system 120. Upon establishing the first wireless connection, a communication session may be initiated between internal entity computing system 120 and local user computing device 150.

At step 205, the request for user profile may be transmitted from the local user computing device 150 to the internal entity computing system 120. For instance, the request for user profile may be transmitted during the communication session initiated upon establishing the first wireless connection.

With reference to FIG. 2B, at step 206, the request for user profile may be received by the internal entity computing system 120 and executed. For instance, executing the request may include querying a database in the internal entity computing system 120 storing a plurality of user data, user profiles, and the like.

At step 207, the requested user profile may be retrieved. At step 208, the internal entity computing system 120 may transmit the requested user profile to the local user computing device 150. For instance, the user profile may be transmitted during the communication session initiated upon establishing the first wireless connection.

At step 209, the local user computing device 150 may receive the user profile. In some examples, receiving the user profile may cause some fields on a user interface to populate (e.g., account information, transaction history, or the like). Based on data stored within the user profile, at step 210, the user may be authenticated. For instance, authentication data received from the user requesting redemption of the instrument may be compared to pre-stored data extracted from the user profile and compared to determine whether a match exists. If so, the user may be authenticated. If not, a request for additional authenticating information may be requested and/or the request for redemption of the instrument may be denied.

With reference to FIG. 2C, at step 211, a scan of the instrument for redemption may be initiated and/or executed. For instance, local user computing device 150 may transmit an instruction or command to a scanning device to initiate scanning of the instrument for redemption. In some examples, the scanning device may be a driverless device. In some arrangements, scanning the device may include physically moving the device through a portion of the scanner.

At step 212, image data and/or metadata may be captured via the scanning operation. The image data may include an image of the instrument. Additional information, metadata, and the like, may include a serial number of the instrument, payee of the instrument, type or series of instrument, and the like. In some arrangements, some or all of the scanned instrument data that is captured may be used to populate one or more fields of a user interface displayed by the local user computing device 150.

At step 213, a connection may be established between the local user computing device 150 and the instrument redemption computing platform 110. For instance, a second wireless connection may be established between the local user computing device 150 and the instrument redemption computing platform 110. Upon establishing the second wireless connection, a communication session may be initiated between instrument redemption computing platform 110 and local user computing device 150.

At step 214, the local user computing device 150 may transmit the image data and metadata, as well as any additional data, to the instrument redemption computing platform 110. In some examples, the user profile and/or user profile data may be transmitted to the instrument redemption computing platform 110. In some examples, the data may be transmitted during the communication session initiated upon establishing the second wireless connection.

At step 215, the image data, metadata, additional data, user profile, and the like, may be received by the instrument redemption computing platform.

With reference to FIG. 2D, at step 216, one or more redemption functions may be initiated in response to receiving the data from the local user computing device 150. For instance, functions associated with redemption of a particular type of instrument that were previously disabled may be enabled or activated. For instance, a connection with a third party computing system may be initiated, in real-time, to retrieve data associated with the redemption.

Accordingly, at step 217, a connection may be established between the instrument redemption computing platform 110 and external entity computing system 140. For instance, a third wireless connection may be established between the instrument redemption computing platform 110 and the external entity computing system 140. Upon establishing the third wireless connection, a communication session may be initiated between external entity computing system 140 and instrument redemption computing platform 110.

At step 218, the data captured by scanning the instrument may be transmitted from the instrument redemption computing platform 110 to the external entity computing system 140. For instance, the data captured via scanning, such as image data, metadata, and the like, may be transmitted during the communication session initiated upon establishing the third wireless connection.

At step 219, the external entity computing system 140 may receive the data and process the data. For instance, data may be extracted to identify a serial number associated with the instrument, a type or series of the instrument, an issue date of the instrument, or the like.

Based on the extracted data, at step 220, the external entity computing system 140 may validate the instrument. For instance, the external entity computing system 140 may confirm that the instrument is valid by, for instance, comparing the extracted serial number and/or series or type to a list or database storing issued instruments. If the data matches that of an issued instrument, the instrument may be considered valid and an indication of validity may be generated.

With reference to FIG. 2E, at step 221, a redemption value associated with the instrument may be determined. For instance, the external entity computing system 140 may determine, in real-time, a current value associated with the instrument. The value may be based on an original purchase price of the instrument, a date of purchase of the instrument, a type of series of the instrument, a current date, and the like. In some examples, the value for redemption may be greater than a face value of the instrument due to insurance earned on the instrument. In some examples, determining a value may include determining whether the instrument has reached a maturity date (e.g., a minimum amount of time that the instrument must be held before reaching full face value). The redemption value may be based on real-time interest information for the particular instrument.

At step 222, the indication of validity and redemption value may be transmitted from the external entity computing system 140 to the instrument redemption computing platform 110.

For instance, the validity information and redemption value may be transmitted during the communication session initiated upon establishing the third wireless connection. In some examples, after transmitting the validity indication and redemption value for the instrument, the communication session may be terminated and wireless connection disconnected such that, should another request for redemption of an instrument be received, another wireless connection between the instrument redemption computing platform 110 and the external entity computing system 140 would be established.

At step 223, the validation indication and redemption value may be received by the instrument redemption computing platform 110. At step 224, the validation indication and redemption value may be analyzed to determine that the instrument is valid and to extract a redemption value for the instrument.

At step 225, the instrument redemption computing platform 110 may integrate the validity indication and/or redemption value into other data stored by the instrument redemption computing platform 110 and/or used by the instrument redemption computing platform 110 to process the requested redemption. In some examples, integrating the data might not require additional formatting as the data may be received from the external entity computing system 140 in a format that is seamlessly integrated into the existing data. Additionally or alternatively, the validity data and redemption value may be formatted prior to integration. In some arrangements, integrating and/or storing the data may cause the data to populate one or more fields of a user interface displayed by the local user computing device 150 (e.g., during the course of the redemption process).

With reference to FIG. 2F, at step 226, the instrument redemption computing platform 110 may process redemption of the instrument. For instance, the determined value may be used to provide funds to the requesting user in an amount of the determined value. Accordingly, one or more reconciliation processes, modifications to one or more user accounts, or the like may be executed.

At step 227, the user profile may be updated based on redemption of the instrument. For instance, a transaction history associated with the user profile (e.g., received with the instrument data) may be updated based on redemption of the instrument.

At step 228, a connection may be established between instrument redemption computing platform 110 and the internal entity computing system 120. For instance, a fourth wireless connection may be established between the instrument redemption computing platform 110 and the internal entity computing system 120. Upon establishing the fourth wireless connection, a communication session may be initiated between internal entity computing system 120 and instrument redemption computing platform.

At step 229, the instrument redemption computing platform 110 may transmit the updated user profile to the internal entity computing system 120. For instance, the updated user profile may be transmitted during the communication session initiated upon establishing the fourth wireless connection.

At step 230, the internal entity computing system may receive the updated user profile and store it (e.g., in one or more databases).

With reference to FIG. 2G, at step 231, a redemption output may be generated. For instance, one or more user interfaces indicating the validity of the instrument, redemption value, how the value was provided to the user (e.g., account credit, cash, or the like), may be generated.

At step 232, the instrument redemption computing platform 110 may transmit the generated redemption output to the local user computing device 150. For instance, the instrument redemption output may be transmitted via a previously established wireless connection or a new connection may be established and the output may be transmitted.

At step 233, the local user computing device 150 may display the generated redemption output. For instance, the redemption output may include one or more instructions or commands that, when received by the local user computing device 150, may be executed and cause the one or more user interfaces to be displayed by a display of the local user computing device 150.

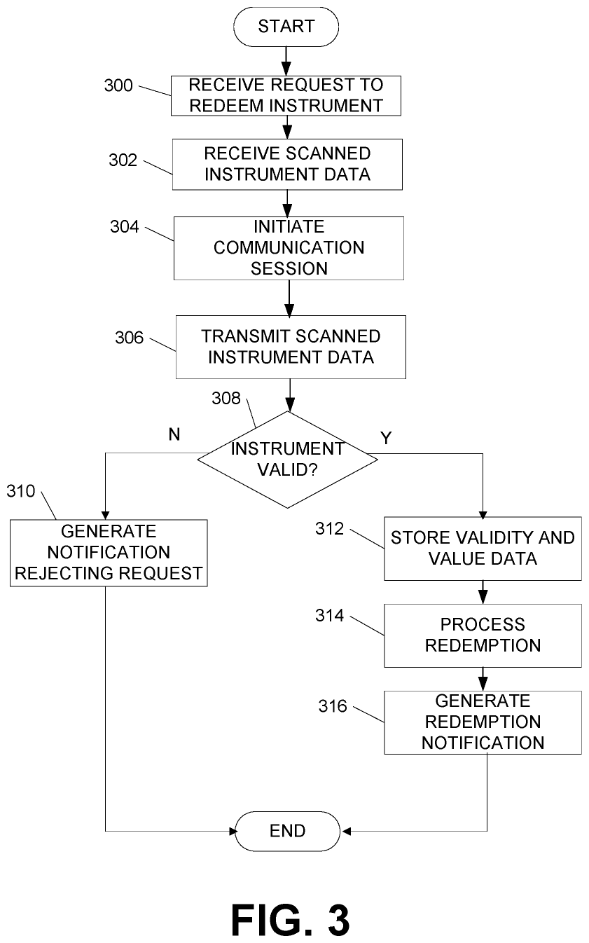

FIG. 3 is a flow chart illustrating one example method of implementing dynamic instrument redemption functions according to one or more aspects described herein. The processes illustrated in FIG. 3 are merely some example processes and functions. The steps shown may be performed in the order shown, in a different order, more steps may be added, or one or more steps may be omitted, without departing from the invention. In some examples, one or more steps may be performed simultaneously with other steps shown and described.

At step 300, a request to redeem an instrument may be received. In some examples, the request to redeem the instrument may be received from a local user computing device 150 associated with a first entity implementing the instrument redemption computing platform 110 (e.g., via a private network).

At step 302, scanned instrument data may be received. For instance, the local user computing device 150 may capture scanned instrument data by scanning (e.g., via a driverless device in communication with the local user computing device 150) the instrument and capturing image data, metadata, and the like. The scanned instrument data may include an image of the instrument, a series of the instrument, a date of issue of the instrument, a face value of the instrument, and the like. In some examples, receiving the scanned instrument data may include receiving user profile data associated with a user requesting redemption of the instrument.

At step 304, responsive to receiving the scanned instrument data, the instrument redemption computing platform 110 may initiate a communication session with an external entity computing system 140 associated with a second entity different from the first entity. For instance, receiving the request to redeem the instrument and the scanned instrument data may cause the instrument redemption computing platform 110 to establish a wireless connection (if one has not already been established) with external entity computing system 140 and initiate a communication session. In some examples, a communication session may be established each time a request to redeem is received. Accordingly, if a single instrument is being redeemed, the communication session may be initiated in response to the single instrument. Additionally or alternatively, if multiple instruments are being redeemed, the scanned instrument data may include data for all instruments (or a portion of the instruments) and the communication session may be initiated in response to the request to redeem the batch of instruments. This may improve efficiency in determining validity and obtaining value data because multiple instruments may be evaluated in a single communication session.

At step 306, once the communication session is established, the scanned instrument data, or a portion thereof (e.g., data extracted from the scanned instrument data) may be transmitted from the instrument redemption computing platform 110 to the external entity computing system 140.

At step 308, an indication of validity of the instrument may be received by the instrument redemption computing platform 110 and from the external entity computing system 140. For instance, the external entity computing system 140 may evaluate the instrument to determine whether it is valid and, if so, identify a value associated with the instrument. That data may then be transmitted to the instrument redemption computing platform 110 and, at step 308, analyzed to determine whether it includes an indication that the instrument is valid.

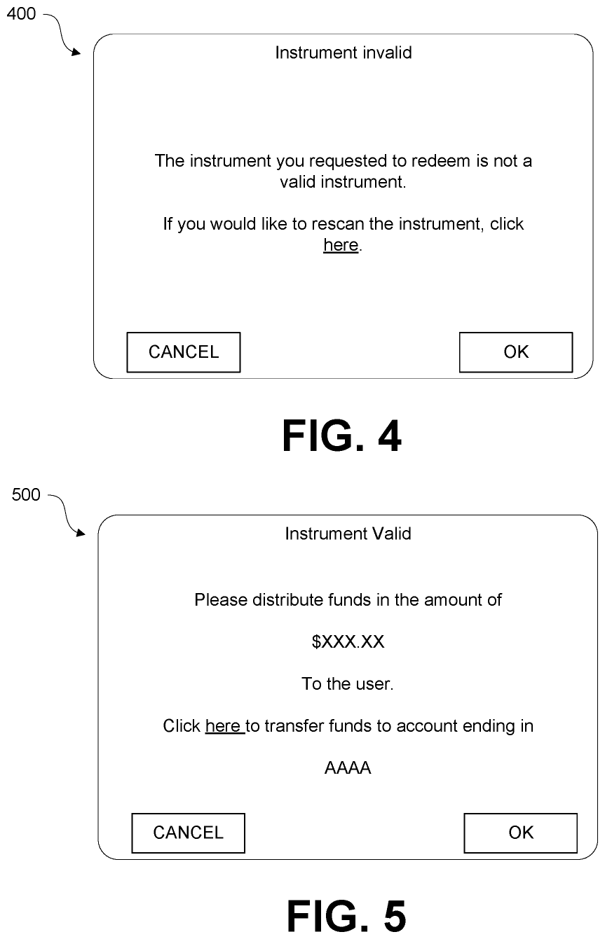

If, at step 308, the instrument is not valid, a notification rejecting the request to redeem the instrument may be generated by the instrument redemption computing platform 110 at step 310. The notification may be transmitted to, for instance, local user computing device 150, and caused to display on a display of the local user computing device 150. FIG. 4 illustrates one example user interface 400 including a notification that the instrument is invalid. The user interface 400 includes an indication that the instrument has been deemed in valid and also gives an option to re-scan the instrument, have the instrument reevaluated (e.g., in case an error occurred).

If, at step 308, the instrument is valid, the validity and value data may be stored by the instrument redemption computing platform 110 at step 312. In some examples, the validity and redemption data may be integrated into previously stored data.

At step 314, the requested redemption may be processed. For instance, a value associated with the instrument being redeemed may be transferred to a user or user account. In addition, one or more entity systems may be updated based on the redemption. For instance, a user profile may be updated and stored, user account data may be updated, and the like.

At step 316, a notification including a redemption output may be generated and transmitted to, for instance, local user computing device 150, for display by a display of the local user computing device 150. FIG. 5 illustrates one example notification including a redemption output. The user interface 500 shown in FIG. 5 includes an indication that the instrument is valid and includes a value determined or identified for redemption of the instrument. In some examples, the user interface 500 may include one or more selectable options to transfer funds in the designated amount to one or more user accounts. In some examples, the account data may be retrieved from the user profile, based on authentication of the user, or the like.

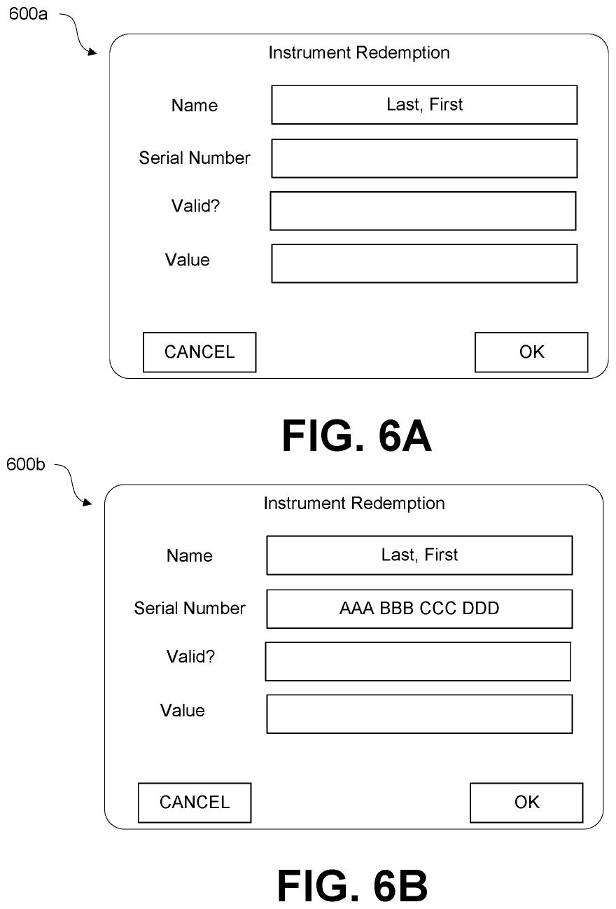

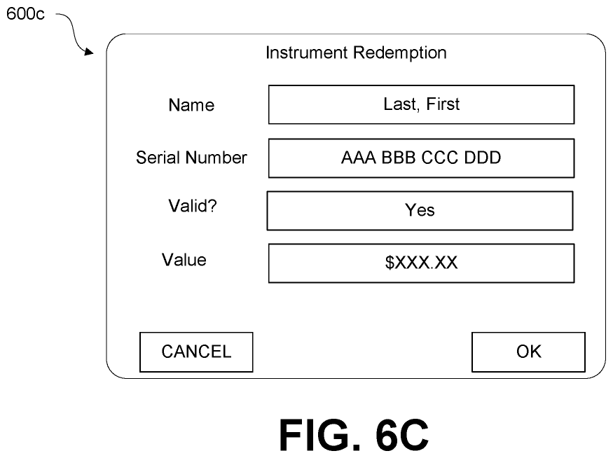

FIGS. 6A-6C illustrate a series of interactive user interfaces including fields with pre-populated data in accordance with one or more aspects described herein. For instance, in FIG. 6A, user interface 600a includes an indication that instrument redemption is being performed and a name of a user requesting redemption. The user name may be pre-populated based on retrieved user profile data, in some examples.

FIG. 6B illustrates the interactive user interface 600b having additional fields pre-populated. For instance, after scanning the instrument being redeemed, a serial number associated with the instrument may be pre-populated in a field on the user interface 600b. In examples in which more than one instrument is being redeemed, a scroll bar may appear enabling a user to view additional portions of the field.

FIG. 6C illustrates the interactive user interface 600c having still additional fields pre-populated. For instance, after transmitting the scanned image data to the instrument redemption computing platform 110 for processing, the validity and value data may be pre-populated in one or more fields in interface 600c. Accordingly, the banking associate may receive all necessary information to perform the redemption process but the data may be received from the one or more systems executing the processes.

The fields provided in user interfaces 600a-600c are merely some example fields that may be displayed, pre-populated, or the like. More or additional fields, or alternative fields, may be provided without departing from the invention.

As discussed herein, arrangements described provide efficient, scalable solutions for shortcomings associated with convention instrument redemption processes. As discussed, the arrangements described herein enable real-time validity and value determination based on real-time interest tables, rather than stagnant data tables updated at predetermined times. This improves efficiency and accuracy in instrument redemption. Further, the arrangements described enable redemption of multiple instruments (e.g., more than 10, more than 50, more than 100, or the like) at the point of presentment (e.g., at a banking center), rather than requiring transfer to an alternate location for further processing. One or more aspects of the arrangements described herein may be performed in real-time or near real-time.

As also discussed, the arrangements described herein involve communication between multiple systems and devices. For instance, receiving scanned instrument data may cause a computing platform to automatically initiate a communication session with an external entity computing system that may then evaluate validity and determine value. Further, one or more user interfaces displayed by, for instance, the local user computing device, may be populated with data received from a plurality of systems, devices, and the like. For instance, scanning the one or more instruments for redemption may cause one or more fields of a user interface to pre-populate. As the redemption process continues, one or more additional fields may be pre-populated with data obtained from other sources (e.g., validity data, value data, and the like). Accordingly, by automatically populating fields with data obtained from various systems and devices, accuracy and efficiency associated with redemption processes are improved.

In some examples, aspects discussed herein may also enable or improve detection of potential unauthorized activity during instrument redemption. For instance, because of the real-time redemption nature of the arrangements described herein, user profile data of a user may be compared to current data of a user to detect potential unauthorized activity. For instance, if a user typically visits a first banking center and the user profile data indicates this in the transaction history, the user attempting to redeem an instrument at a different location or a location greater than a predetermined distance from the expected location, may be flagged as potential unauthorized activity and additional authentication measures may be executed. Various other user data/current data may be used to detect unauthorized activity without departing from the invention.

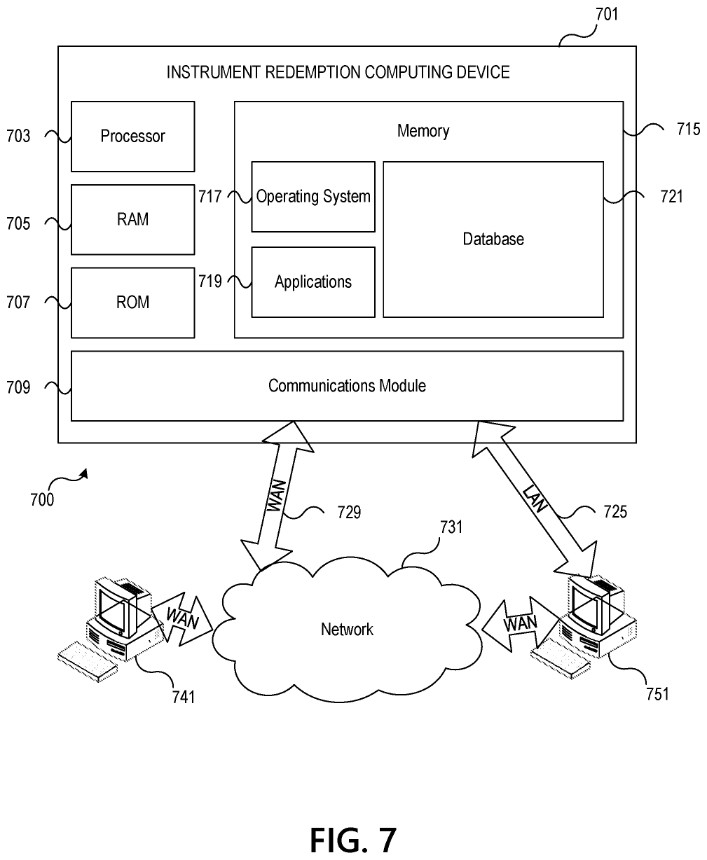

FIG. 7 depicts an illustrative operating environment in which various aspects of the present disclosure may be implemented in accordance with one or more example embodiments. Referring to FIG. 7, computing system environment 700 may be used according to one or more illustrative embodiments. Computing system environment 700 is only one example of a suitable computing environment and is not intended to suggest any limitation as to the scope of use or functionality contained in the disclosure. Computing system environment 700 should not be interpreted as having any dependency or requirement relating to any one or combination of components shown in illustrative computing system environment 700.

Computing system environment 700 may include instrument redemption computing device 701 having processor 703 for controlling overall operation of instrument redemption computing device 701 and its associated components, including Random Access Memory (RAM) 705, Read-Only Memory (ROM) 707, communications module 709, and memory 715. instrument Redemption computing device 701 may include a variety of computer readable media. Computer readable media may be any available media that may be accessed by instrument redemption computing device 701, may be non-transitory, and may include volatile and nonvolatile, removable and non-removable media implemented in any method or technology for storage of information such as computer-readable instructions, object code, data structures, program modules, or other data. Examples of computer readable media may include Random Access Memory (RAM), Read Only Memory (ROM), Electronically Erasable Programmable Read-Only Memory (EEPROM), flash memory or other memory technology, Compact Disk Read-Only Memory (CD-ROM), Digital Versatile Disk (DVD) or other optical disk storage, magnetic cassettes, magnetic tape, magnetic disk storage or other magnetic storage devices, or any other medium that can be used to store the desired information and that can be accessed by instrument redemption computing device 601.

Although not required, various aspects described herein may be embodied as a method, a data transfer system, or as a computer-readable medium storing computer-executable instructions. For example, a computer-readable medium storing instructions to cause a processor to perform steps of a method in accordance with aspects of the disclosed embodiments is contemplated. For example, aspects of method steps disclosed herein may be executed on a processor on instrument redemption computing device 701. Such a processor may execute computer-executable instructions stored on a computer-readable medium.

Software may be stored within memory 715 and/or storage to provide instructions to processor 703 for enabling instrument redemption computing device 701 to perform various functions as discussed herein. For example, memory 715 may store software used by instrument redemption computing device 701, such as operating system 717, application programs 719, and associated database 721. Also, some or all of the computer executable instructions for instrument redemption computing device 701 may be embodied in hardware or firmware. Although not shown, RAM 705 may include one or more applications representing the application data stored in RAM 705 while instrument redemption computing device 701 is on and corresponding software applications (e.g., software tasks) are running on instrument redemption computing device 701.

Communications module 709 may include a microphone, keypad, touch screen, and/or stylus through which a user of instrument redemption computing device 701 may provide input, and may also include one or more of a speaker for providing audio output and a video display device for providing textual, audiovisual and/or graphical output. Computing system environment 600 may also include optical scanners (not shown).

Instrument redemption computing device 701 may operate in a networked environment supporting connections to one or more remote computing devices, such as computing devices 741 and 751. Computing devices 741 and 751 may be personal computing devices or servers that include any or all of the elements described above relative to instrument redemption computing device 701.

The network connections depicted in FIG. 7 may include Local Area Network (LAN) 725 and Wide Area Network (WAN) 729, as well as other networks. When used in a LAN networking environment, instrument redemption computing device 701 may be connected to LAN 725 through a network interface or adapter in communications module 709. When used in a WAN networking environment, instrument redemption computing device 701 may include a modem in communications module 709 or other means for establishing communications over WAN 729, such as network 731 (e.g., public network, private network, Internet, intranet, and the like). The network connections shown are illustrative and other means of establishing a communications link between the computing devices may be used. Various well-known protocols such as Transmission Control Protocol/Internet Protocol (TCP/IP), Ethernet, File Transfer Protocol (FTP), Hypertext Transfer Protocol (HTTP) and the like may be used, and the system can be operated in a client-server configuration to permit a user to retrieve web pages from a web-based server.

The disclosure is operational with numerous other computing system environments or configurations. Examples of computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like that are configured to perform the functions described herein.

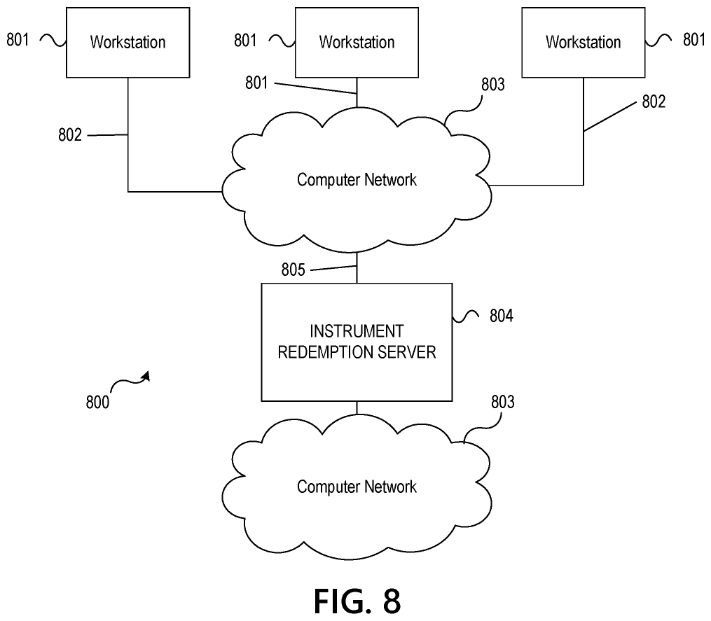

FIG. 8 depicts an illustrative block diagram of workstations and servers that may be used to implement the processes and functions of certain aspects of the present disclosure in accordance with one or more example embodiments. Referring to FIG. 8, illustrative system 800 may be used for implementing example embodiments according to the present disclosure. As illustrated, system 800 may include one or more workstation computers 801. Workstation 801 may be, for example, a desktop computer, a smartphone, a wireless device, a tablet computer, a laptop computer, and the like, configured to perform various processes described herein. Workstations 801 may be local or remote, and may be connected by one of communications links 802 to computer network 803 that is linked via communications link 805 to instrument redemption server 804. In system 800, instrument redemption server 804 may be a server, processor, computer, or data processing device, or combination of the same, configured to perform the functions and/or processes described herein. Server 804 may be used to receive requests to redeem instruments, initiate communications with an external system, receive and evaluate validity indications and identified value, process redemption, generate notifications, and the like.

Computer network 803 may be any suitable computer network including the Internet, an intranet, a Wide-Area Network (WAN), a Local-Area Network (LAN), a wireless network, a Digital Subscriber Line (DSL) network, a frame relay network, an Asynchronous Transfer Mode network, a Virtual Private Network (VPN), or any combination of any of the same.

Communications links 802 and 805 may be communications links suitable for communicating between workstations 801 and instrument redemption server 704, such as network links, dial-up links, wireless links, hard-wired links, as well as network types developed in the future, and the like.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, Application-Specific Integrated Circuits (ASICs), Field Programmable Gate Arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, one or more steps described with respect to one figure may be used in combination with one or more steps described with respect to another figure, and/or one or more depicted steps may be optional in accordance with aspects of the disclosure.

What is claimed is:

1. A computing platform associated with a first entity, comprising:
at least one processor;
a communication interface communicatively coupled to the at least one processor; and
a memory storing computer-readable instructions that, when executed by the at least one processor, cause the computing platform to:
receive a request to redeem an instrument;
receive scanned instrument data including image data and metadata of a scanned instrument;
responsive to receiving the scanned instrument data, initiate a communication session with a computing system operated by a second entity, different from the first entity, the computing system storing redemption information for a plurality of instruments;
transmit, in real-time and to the computing system, the scanned instrument data for validation of the instrument and identification of a redemption value of the instrument;
receive, in real-time and from the computing system, an indication that the instrument is valid and the identified redemption value associated with the instrument;
integrate, in real-time, the received indication that the instrument is valid and redemption value with data stored by the computing platform; and
process, in real-time, the redemption of the instrument.

2. The computing platform of claim 1, wherein the scanned instrument data includes a series of the instrument and a date of the instrument.

3. The computing platform of claim 1, wherein the communication session with a computing system operated by a second entity is initiated in response to each request to redeem an instrument.

4. The computing platform of claim 1, wherein the redemption information for the plurality of instruments includes real-time interest data.

5. The computing platform of claim 1, further including instructions that, when executed, cause the computing platform to:
receive a user profile associated with a user requesting redemption of the instrument.

6. The computing platform of claim 5, further including instructions that, when executed, cause the computing platform to:
update the user profile based on processing the redemption of the instrument.

7. The computing platform of claim 1, further including instructions that, when executed, cause the computing platform to:
generate a redemption notification; and
transmit the redemption notification to a computing device for display.

8. A method, comprising:
receiving, by a computing platform of a first entity, the computing platform having at least one processor and memory, a request to redeem an instrument;
receiving, by the at least one processor, scanned instrument data including image data and metadata of a scanned instrument;
responsive to receiving the scanned instrument data, initiating, by the at least one processor, a communication session with a computing system operated by a second entity, different from the first entity, the computing system storing redemption information for a plurality of instruments;
transmitting, by the at least one processor, in real-time and to the computing system, the scanned instrument data for validation of the instrument and identification of a redemption value of the instrument;
receiving, by the at least one processor, in real-time and from the computing system, an indication that the instrument is valid and the identified redemption value associated with the instrument;
integrating, by the at least one processor and in real-time, the received indication that the instrument is valid and redemption value with data stored by the computing platform; and
processing, by the at least one processor and in real-time, the redemption of the instrument.

9. The method of claim 8, wherein the scanned instrument data includes a series of the instrument and a date of the instrument.

10. The method of claim 8, wherein the communication session with a computing system operated by a second entity is initiated in response to each request to redeem an instrument.

11. The method of claim 8, wherein the redemption information for the plurality of instruments includes real-time interest data.

12. The method of claim 8, further including:
receiving, by the at least one processor, a user profile associated with a user requesting redemption of the instrument.

13. The method of claim 12, further including instructions that, when executed, cause the computing platform to:
updating, by the at least one processor, the user profile based on processing the redemption of the instrument.

14. The method of claim 8, further including instructions that, when executed, cause the computing platform to:
generating, by the at least one processor, a redemption notification; and
transmitting, by the at least one processor, the redemption notification to a computing device for display.

15. One or more non-transitory computer-readable media storing instructions that, when executed by a computing platform associated with a first entity and comprising at least one processor, memory, and a communication interface, cause the computing platform to:
receive a request to redeem an instrument;
receive scanned instrument data including image data and metadata of a scanned instrument;
responsive to receiving the scanned instrument data, initiate a communication session with a computing system operated by a second entity, different from the first entity, the computing system storing redemption information for a plurality of instruments;
transmit, in real-time and to the computing system, the scanned instrument data for validation of the instrument and identification of a redemption value of the instrument;
receive, in real-time and from the computing system, an indication that the instrument is valid and the identified redemption value associated with the instrument;
integrate, in real-time, the received indication that the instrument is valid and redemption value with data stored by the computing platform; and
process, in real-time, the redemption of the instrument.

16. The one or more non-transitory computer-readable media of claim 15, wherein the scanned instrument data includes a series of the instrument and a date of the instrument.

17. The one or more non-transitory computer-readable media of claim 15, wherein the communication session with a computing system operated by a second entity is initiated in response to each request to redeem an instrument.

18. The one or more non-transitory computer-readable media of claim 15, wherein the redemption information for the plurality of instruments includes real-time interest data.

19. The one or more non-transitory computer-readable media of claim 15, further including instructions that, when executed, cause the computing platform to:
receive a user profile associated with a user requesting redemption of the instrument.

20. The one or more non-transitory computer-readable media of claim 19, further including instructions that, when executed, cause the computing platform to:
update the user profile based on processing the redemption of the instrument.

21. The one or more non-transitory computer-readable media of claim 15, further including instructions that, when executed, cause the computing platform to:
generate a redemption notification; and
transmit the redemption notification to a computing device for display.
